(19) United States
(12) Patent Application Publication
(10) Pub. No.: US 2018/0217641 A1
(43) Pub. Date: Aug. 2, 2018

(54) Casing Closure For A Casing Of An Electronic Device And Its Use

(71) Applicant: FUJITSU LIMITED, Kawasaki-shi (JP)

(72) Inventor: Bernhard Gut, München (DE)

(73) Assignee: FUJITSU LIMITED, Kawasaki-shi (JP)

(21) Appl. No.: 15/868,114

(22) Filed: Jan. 11, 2018

(30) Foreign Application Priority Data
Jan. 30, 2017 (DE) 102017101748.8

(51) Int. Cl. G06F 1/18

(52) U.S. Cl. CPC G06F 1/181

(57) ABSTRACT

The casing closure comprises an actuation device for opening and/or closing the casing, a reception device for rotational or pivotable fastening of the actuation device at a part of the casing and a pin-like connection element for mechanically coupling the actuation device to the reception device. The pin-like connection element comprises at least one latch element extending in the radial direction. The actuation device and/or the reception device comprises at least one elastic securing element, which is configured and arranged in such a way that the latch element of the pin-like connection element latches with the elastic securing element when the pin-like connection element is completely inserted in the reception device for the coupling of the actuation device.

The invention relates to a casing closure for a casing of an electronic device, in particular for a computer casing, including an actuating device for opening and/or closing of the casing. The invention further relates to the use of such a casing closure in a casing of an electronic device with a lockable casing cover.

From the prior art, various casing closures are known for casings of electronic devices. Besides simple screw closures, which require a corresponding tool to be opened or closed, other tool-free operable casing closures with rotatable or pivotable actuating devices are also known. When mounting such actuating devices on a receiving device, a pin-like connecting element is generally employed for mechanical coupling, which forms a rotating or pivoting axis of the actuating device. Depending on the configuration of the actuating device, this covers such a connecting element partially or completely, so that a securing of the connecting element under the actuating device, by means of safety washers or safety splints, is only possible with effort. This is disadvantageous, in particular in the mass production of electronic devices, such as computers.

The object underlying the invention is to describe a casing closure for a casing of an electronic device, which solves or minimizes the above-named problem. In particular, a casing closure is to be described which is simple to mount.

The above-named object is achieved through a casing closure for a casing of an electronic device, in particular for a computer system, which comprises an actuating device for opening and/or closing of the casing, a receiving device for rotatably or pivotably fastening the actuating device on a part of the casing, and a pin-like connecting element for mechanical coupling of the actuating device on the receiving device. Here, the pin-like connecting element comprises at least one latch element extending in radial direction. The actuating device and/or the receiving device comprises at least one elastic securing element, which is configured and arranged in such a way that the latch element of the pin-like connecting element latches with the elastic securing element when the pin-like connecting element is completely inserted into the receiving device for coupling of the actuating device.

Through the provision of a protruding or recessed latch element on the pin-like connecting element, as well as of an elastic securing element on the actuating device and/or the receiving device, the provision of additional parts for securing the connecting element, such as in particular safety washers or safety splints, can be dispensed with. Besides the introduction of the pin-like connecting element, no additional steps are needed for mounting of the casing closure. Thus, the mounting of the actuating device on the receiving device is significantly simplified.

In at least one embodiment, the pin-like connecting element and/or the receiving device are formed from a metallic material or a plastic material, and ensures a high mechanical stability. In at least one embodiment, the actuating device is formed from of a plastic material, and enables an appealing design.

In at least one embodiment, the elastic securing element is configured as a securing rip integrally formed to the actuating device or the receiving device, and the latch element extending in radial direction comprises at least one protrusion or recess. In this manner, the securing element can be produced simply and in one piece together with the actuating device, for example as injection-molded part, which latches behind a protrusion of the connecting element, or engages in a recess of the securing element. For example, the latch element can be configured as circumferential protrusion with a chamfer in front in the direction of insertion.

In at least one embodiment, the pin-like connecting element comprises at least a first portion, located at the front in a direction of insertion, with a first outer diameter and at least a second portion, located behind it in the direction of insertion, with a second outer diameter, wherein the second outer diameter is greater than the first outer diameter, and wherein the projecting latch element is arranged in the first portion. Such a configuration in particular makes it possible that a latch element projecting in the first portion can simply be guided through corresponding openings with a diameter corresponding to the second portion.

In at least one embodiment, the pin-like connecting element comprises at least one third portion, located behind the second portion in the direction of insertion, with a third outer diameter, wherein the third outer diameter is greater than the second outer diameter. Such a third portion serves in particular to define a stopper in a completely inserted position of the pin-like connecting element.

In at least one embodiment, the receiving device comprises at least two openings for storing the pin-like connecting element, wherein an inner diameter of the first opening substantially corresponds to the outer diameter of the first portion, and an inner diameter of the second opening substantially corresponds to the outer diameter of the second portion. For example, the receiving device can be configured substantially U-shaped, and the first opening can be arranged in a first U-leg, and the second opening can be arranged in a second U-leg opposite the first U-leg. Such a configuration of the receiving device enables a simple and stable receiving of the actuating device.

In at least one embodiment, the elastic securing element is arranged in the area of the first or second opening and/or in an area between the first and second opening. In this manner, the elastic securing element is covered by the actuating device and/or the receiving device, so that a damaging or an unintentional loosening of the elastic securing element is avoided.

The disclosed casing closure is suitable for use in a casing of an electronic device with a lockable casing cover (German “Gehäusedeckel”, also: “casing lid”), wherein the receiving device is secured to the casing cover, and the actuating device releases a locking of the casing cover upon actuation. The casing closure is particularly suited for closing a computer casing with a lockable side panel.

Further advantageous embodiments of the invention are disclosed in the dependent claims, as well as in the subsequent detailed description.

The invention will hereinafter be described in detail by means of an exemplary embodiment with reference to the Figures. The Figures show in:

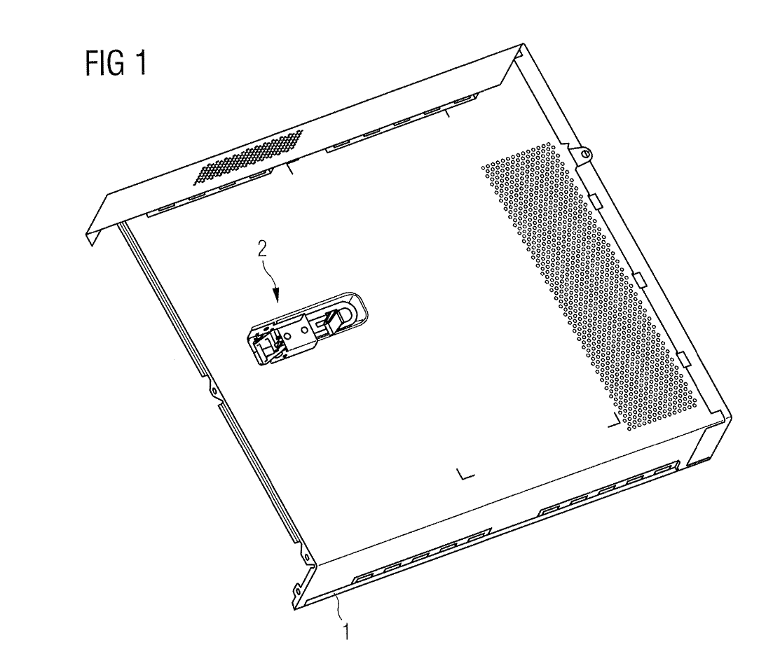

FIG. 1 a casing cover of an electronic device with a casing closure arranged thereon,

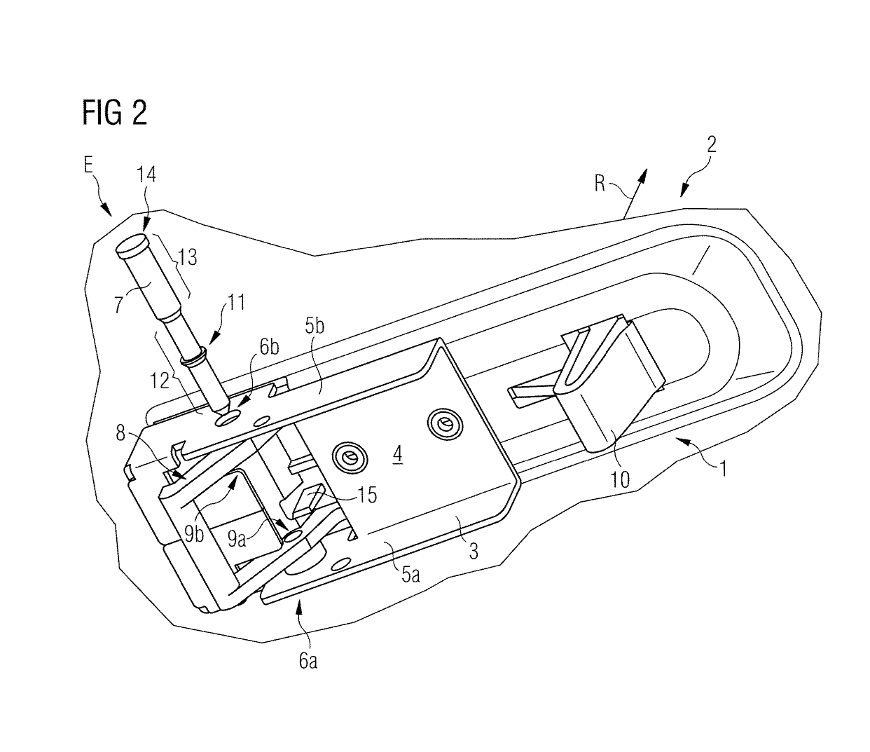

FIG. 2 a casing closure according to an embodiment of the invention in a first mounting stage,

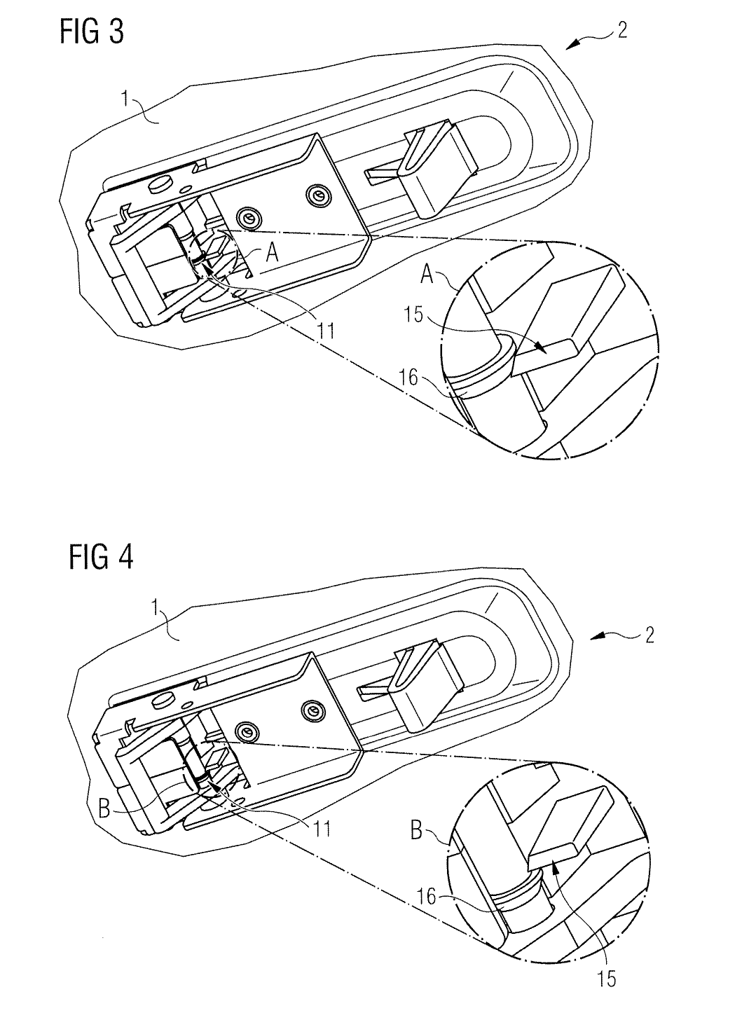

FIG. 3 the casing closure according to FIG. 2 in a second mounting stage, and

FIG. 4 the casing closure according to FIG. 2 in a third mounting stage.

FIG. 1 shows a part of a casing of an electronic device. In particular, FIG. 1 shows a casing cover 1 of a computer casing, which, by means of a casing closure 2, can be locked on another part of the computer casing (not shown).

FIG. 2 shows a detailed representation of the casing closure 2. The casing closure 2 includes in particular a receiving device 3, in the type of a metal bracket, which is fastened to the casing cover 1. For example, the receiving device 3 can be riveted to the casing cover 1 or screwed thereto. The receiving device 3 comprises for this purpose a surface area 4 and two legs 5a and 5b arranged perpendicularly thereto. The legs 5a and 5b are arranged parallel to one another, and thereby form, together with the surface area 4, a substantially U-shaped metal bracket. In each of the legs 5a and 5b, an opening 6a (covered in FIG. 2), or rather 6b, is arranged, respectively.

The openings 6a and 6b serve to receive an axis of rotation configured as a pin-like connecting element 7. In the exemplary embodiment, the connecting element is configured rotationally symmetrically to its longitudinal axis. As shown in FIG. 2, the pin-like connecting element 7 is guided through the openings 6b and 6a of the receiving device 3, as well as corresponding openings 9b and 9a of an actuating device 8 in the form of a plastic lever. Here, the inner diameter of the openings 9a and 9b of the actuating device 8 substantially corresponds to the inner diameter of the corresponding opening 6a and 6b of the receiving device 3. As detailed later, the inner diameters of the first openings 6a and 9a differ from the inner diameters of the second openings 6b and 9b.

As can be further discerned in FIG. 2, the actuating device 8 can be pivoted around the longitudinal axis of the connecting element 7. In the closed state of the casing of the electronic device, a locking element 10 of the actuating device 8 here passes through a corresponding opening of the casing cover 1, and causes its locking. If the actuating device 8 conversely is tilted away in the actuating direction R (in FIG. 2 backward), the corresponding locking is released.

As shown in FIGS. 2 to 4, the pin-like connecting element 7 comprises a latch element 11 projecting in radial direction. The projecting latch element 11 secures the connecting element 7 from slipping out from the openings 6a and 6b, as well as 9a and 9b of the receiving element 3 or the actuating device 8.

In the exemplary embodiment, the connecting element 7 is designed in a stepped manner. Here, the latch element 11 is arranged on a first portion 12 of the connecting element 7 located in front in the direction of insertion E. Here, the largest outer diameter of the latch element 11 corresponds approximately to the outer diameter of a second portion 13 of the connecting element 7 located behind it. The connecting element 7 ends in a head-shaped third portion 14, which prevents a complete penetration of the pin-like connecting element 7 through the second opening 6b of the receiving device 3. In the illustrated exemplary embodiment, the inner diameter of the first opening 6a of the receiving device 3, as well as the corresponding first opening 9a of the actuating device 8, is smaller than the inner diameter of the second opening 6b and the associated second opening 9b, and substantially corresponds to the outer diameter of the first portion 12, or of the second portion 13. For example, the diameter of the first openings 6a and 9a is approximately 2.5 mm, and the diameter of the second openings 6a and 9b is approximately 3.5 mm. In other words, the receiving device 3 and the actuating device 8 are configured asymmetrically, so that the connecting element 7 can only be inserted completely into the casing closure 2 in a predetermined direction.

During the introduction of the connecting element 7 in the receiving device 3 and the therein-arranged actuating device 8, the latch element 11 latches, like a barb, behind an elastic securing element 15 arranged on the actuating device 8 in form of an injection-molded safety rib. This process is in particular shown in the segment enlargements of the FIGS. 3 and 4. In the segment enlargement A of FIG. 3, one recognizes in particular that the latch element 11 comprises a chamfer 16 forwardly facing in the direction of insertion E. Upon insertion of the connecting element 7, this chamfer 16 bends the securing element 15 elastically. If the latch element 11 is slid past the securing element 11, the elastic securing element 11 springs back into its unloaded position, and thereby locks the connecting element 7 in the completely inserted state, as shown in FIG. 4 and its segment enlargement B. The provision of further securing measures, such as in particular the provision of a safety splint or a safety washer on the tip of the first portion 12 of the connecting element 7 can therefore be dispensed with.

In the exemplary embodiments represented in FIGS. 2 to 4, the securing element 15 is located in the area of the first portion 12 of the connecting element 7 located at the front in the direction of insertion E, that is, in the area of the first opening 6a of the receiving device 3 or the first opening 9a of the actuating device 8. The securing element 15 can certainly also be completely integrated into one of the openings 6a, 6b, 9a, or 9b of the actuating device 8, or can be arranged on a desired other point between the two openings 9a and 9b. It is likewise possible to fasten the elastic securing element 15 not on the actuating device 8, but on the receiving device 3, or even on a part of the casing cover 1, or to form it as part thereof. In addition, it is possible to provide for a corresponding recess as a latch element in the connecting element besides the circumferential protrusion.

The assembly of the casing closure 2 requires no manual interventions in an area which is fully or partially covered by the actuating device 8 or the receiving device 3. The described casing closure 2 can thereby be mounted, particularly simply, and without use of additional parts or tools, which reduces the mounting time and the financial outlay connected thereto.

### LIST OF REFERENCE CHARACTERS

1 casing cover
2 casing closure
3 receiving device
4 surface area
5a, 5b legs
6a, 6b openings (of the receiving device)
7 pin-like connecting element
8 actuating device
9a, 9b openings (of the actuating device)
10 locking element
11 latch element
12 first portion
13 second portion
14 third portion
15 securing element
16 chamfer
A, B segment enlargements
E direction of insertion (of the connecting element)
R actuating direction (of the actuating device)

1. Computer casing, comprising a side wall and a casing closure secured to the side wall, the casing closure comprising:
an actuation device for opening and/or closing the computer casing;
a reception device for rotational or pivotable fastening of the actuation device at a part of the computer casing; and
a pin-like connection element for mechanically coupling the actuation device to the reception device; wherein
the pin-like connection element comprises at least one latch element extending in the radial direction; and
the actuation device and/or the reception device comprises at least one elastic securing element, which is configured and arranged in such a way that the latch element of the pin-like connection element latches with the elastic securing element when the pin-like connection element is completely inserted in the reception device for the coupling of the actuation device.

2. Computer casing according to claim 1,
wherein the side wall, the pin-like connection element and/or the reception device is formed of a metal material.

3. Computer casing according to claim 1,
wherein the actuation device, the pin-like connection element and/or the reception device is formed of a plastic material.

4. Computer casing according to claim 1,
wherein the elastic securing element is formed as a securing rib molded to the actuation device or the reception device and the latch element extending in the radial direction comprises at least one elevation or depression.

5. Computer casing according to claim 1, wherein the latch element is essentially formed as a circumferential elevation having a chamfer located at the front in the insertion direction.

6. Computer casing according to claim 1, wherein the pin-like connection element comprises at least one first section located at the front in an insertion direction and having a first outer diameter and at least one second section located behind the first section in the insertion direction and having a second outer diameter, wherein the second outer diameter is greater than the first outer diameter and wherein the protruding latch element is arranged in the first section.

7. Computer casing according to claim 6,
wherein the pin-like connection element comprises at least one third section located behind the second region in the insertion direction and having a third outer diameter,
wherein the third outer diameter is greater than the second outer diameter.

8. Computer casing according to claim 6,
wherein the reception device comprises at least two openings for mounting the pin-like connection element, wherein an inner diameter of the first opening corresponds essentially to the outer diameter of the first section and an inner diameter of the second opening essentially corresponds to the outer diameter of the second section.

9. Computer casing according to claim 8,
wherein the reception device is formed essentially U-shaped and the first opening is arranged in a first U-leg and the second opening is arranged in a second U-leg opposite the first U-leg.

10. Computer casing according to claim 8,
wherein the elastic securing element is arranged in the region of the first or second opening and/or in a region between the first and second opening.

11. Casing closure for a casing of an electronic device, comprising:
an actuation device for opening and/or closing the casing;
a reception device for rotational or pivotable fastening of the actuation device at a part of the casing; and
a pin-like connection element for mechanically coupling the actuation device to the reception device; wherein
the pin-like connection element comprises at least one latch element extending in the radial direction; and
the actuation device and/or the reception device comprises at least one elastic securing element, which is configured and arranged in such a way that the latch element of the pin-like connection element latches with the elastic securing element when the pin-like connection element is completely inserted in the reception device for the coupling of the actuation device.

12. Casing closure according to claim 11,
wherein the pin-like connection element and/or the reception device are formed of a metal material or a plastic material, and wherein the actuation device is formed of a plastic material.

13. Casing closure according to claim 11,
wherein the elastic securing element is formed as a securing rib molded to the actuation device or the reception device and the latch element extending in the radial direction comprises at least one elevation or depression.

14. Casing closure according to claim 11, wherein the latch element is essentially formed as a circumferential elevation having a chamfer located at the front in the insertion direction.

15. Casing closure according to claim 11, wherein the pin-like connection element comprises at least one first section located at the front in an insertion direction and having a first outer diameter and at least one second section located behind the first section in the insertion direction and having a second outer diameter, wherein the second outer diameter is greater than the first outer diameter and wherein the protruding latch element is arranged in the first section.

16. Casing closure according to claim 15,
wherein the pin-like connection element comprises at least one third section located behind the second region in the insertion direction and having a third outer diameter,
wherein the third outer diameter is greater than the second outer diameter.

17. Casing closure according to claim 15,
wherein the reception device comprises at least two openings for mounting the pin-like connection element, wherein an inner diameter of the first opening corresponds essentially to the outer diameter of the first section and an inner diameter of the second opening essentially corresponds to the outer diameter of the second section.

18. Casing closure according to claim 17,
wherein the reception device is formed essentially U-shaped and the first opening is arranged in a first U-leg and the second opening is arranged in a second U-leg opposite the first U-leg.

19. Casing closure according to claim 17,
wherein the elastic securing element is arranged in the region of the first or second opening and/or in a region between the first and second opening.

20. Casing closure according to claim 11, wherein the reception device is secured to a lockable casing cover of the electronic device and, upon actuation, the actuation device releases a locking of the casing cover.
